(19) United States
(12) Patent Application Publication
(10) Pub. No.: US 2013/0043288 A1
(43) Pub. Date: Feb. 21, 2013

(54) LEG ASSEMBLY

(71) Applicants: Peter Douglas Hubbard, Christchurch (NZ); Bruce John Robertson, Christchurch (NZ)

(72) Inventors: Peter Douglas Hubbard, Christchurch (NZ); Bruce John Robertson, Christchurch (NZ)

(73) Assignee: HUBCO AUTOMOTIVE LIMITED, Wellington (NZ)

(21) Appl. No.: 13/512,266

(22) PCT Filed: Nov. 29, 2010
(86) PCT No.: PCT/NZ2010/000236

§ 371 Date: Nov. 2, 2012

(30) Foreign Application Priority Data
Dec. 1, 2009 (NZ) 581573

(51) Int. Cl. B60R 9/058

(52) U.S. Cl. 224/331

(57) ABSTRACT

A leg assembly is described that links a roof rack bar to a vehicle roof. The leg assembly utilises a T-bar member linked to a rocker member and via a biasing arrangement, the T-bar flanges impinge with the bar flanges to lock the leg assembly in place or optionally move the leg assembly along the bar length by forcing the T-bar member flanges up from the bar flanges until the desired position is reached before release and re-locking.

### TECHNICAL FIELD

The invention relates to a leg assembly. More specifically, the invention relates to an assembly and related method to link or connect a vehicle roof to a vehicle roof rack.

### BACKGROUND ART

Vehicle roof racks are well known in the art with many products existing relating to a variety of different parts of various roof rack systems and the loads carried by such racks.

A typical design of vehicle roof rack involves fitting of two cross bars across the roof of the vehicle at the front and rear of the vehicle roof. Various items may then be placed onto the cross bars for example, cycle holders, trade rack holders, kayak holders, fishing rod holders, surfboard holders and many other accessory racks or accessory items. The various accessory items may be directly attached to the crossbars or further forward facing racks used on which the accessory item(s) are mounted.

Roof racks are typically connected to a vehicle roof using indentations in the car frame, a channel in the car frame, side rails and so on. Most designs typically utilise a leg assembly between the vehicle roof and roof racks.

One of the difficulties in fitting the leg to the vehicle is being able to adjust the spread of the legs along a roof rack member to cater for the wide variation in vehicle roof widths.

A variety of designs exist for adjusting the spread of legs to cater for varying roof width. One example is use of a bolt that is loosened when adjusting and then tightened when the desired position relative to the roof rack and vehicle roof is reached. While this is simple, adjustment can be difficult as, when the bolt is loose the leg and rack are free to move. There is also little positive feedback to the user when making the adjustment.

One alternative is to use a ratchet system where the roof rack bar has a rack arrangement inside a channel in the rack and the leg communicates with the rack in a ratchet fashion until the correct width is reached. Owing to the ratchet mechanism, the leg cannot be pulled back out thereby holding the leg in place. While this design provides more positive feedback to the user and is stronger, the position of the leg is in part defined by the rack and ratchet assembly and is not infinitely adjustable. A further drawback of this design is that removing the leg back off the rack once pushed in cannot be achieved by the user without use of tools. Further, these designs require use of specific racks or modified racks e.g. those with slots or ratchets racks.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description that is given by way of example only.

### DISCLOSURE OF THE INVENTION

The invention broadly relates to a leg assembly designed to connect or link a vehicle roof to a roof rack. As may be appreciated, such a leg assembly must be strong in order to withstand the forces experienced on the roof of a vehicle in motion and, given the sometimes awkward position of racks of vehicles roofs, the leg assembly should be simple to use and attach. Ideally, the assembly should also be aerodynamic and aesthetically pleasing. The leg should also ideally provide an infinite range of positions at which the leg may be held to the roof rack.

According to a first embodiment there is provided a leg assembly that links a roof rack bar to a foot that couples the leg assembly to a vehicle roof wherein the leg assembly includes:

a T-bar member wherein the flanges of the T-bar member are received within a T-slot in a roof rack bar and impinge on the roof rack T-slot flanges;

a rocker member linked to the T-bar member that rotates about an axis in a vertical plane with respect to the roof rack bar;

a biasing means that biases the T-bar member flanges to impinge with the T-slot roof rack bar flanges;

a fastener linked to the rocker member that acts against the bias action of the biasing means and which adjusts the degree of moment about the T-bar member wherein:

the fastener can be adjusted to lock the T-bar flanges against the roof rack flanges and prevent movement of the leg assembly along the roof rack bar and,
the fastener can be adjusted to reduce and/or remove the impingement of the T-bar member flanges on the rack flanges thereby allowing the leg assembly to be moved along the rack bar channel.

Preferably, the T-bar member flanges impinge on the roof rack T-slot flanges at an angle of 1-25 degrees relative to a perpendicular axis with respect to the roof rack. In a further embodiment, the angle may be 5 to 15 degrees. In the inventor's experience, this angle is critical to operation of the leg assembly. If the angle falls outside of this range, the linkage may become compromised and not provide the strength of connection desired for roof rack applications.

In preferred embodiments, the impingement angle is in a direction towards the inside of the vehicle roof or roof rack inside section. While the angle may be in the opposing direction, an aim of the rack is to enable easy fit which ideally allows the user to move the leg assembly forwards into the rack extrusion yet, during fitting prevent the leg assembly from moving outwards.

Preferably, the leg assembly as claimed in any one of the above claims wherein the bias means is a spring.

In preferred embodiment, the leg assembly includes an enclosure moulding that also acts as a frame to retain the leg assembly T-bar member, rocker member, bias means and at least portion of the fastener. In this embodiment, only the head of the fastener protrudes from the exterior of the leg assembly enclosure. In one embodiment the rocker member is nested within an aperture in the enclosure that allows for a degree of rotation of the rocker member and provides maximum limits of rotation defined by the aperture size.

Preferably, the T-bar member and rocker member are linked by the T-bar member being received and retained within an aperture in the rocker member.

Preferably, the fastener and rocker member are linked via a nut nested between two rocker member legs and wherein the fastener is received and fixed to the nut.

Preferably, the fastener is threaded into the nut.

In one embodiment using a threaded fastener, when the fastener is threaded into the nut, the rocker legs are pulled towards the fastener head thereby rotating the rocker member and forcing the T-bar member flanges to impinge against the T-slot flanges of the roof rack. Conversely, when the fastener is threaded out of the nut, the rocker legs are pushed away from the fastener head thereby rotating the rocker member and moving the T-bar member flanges away from the T-slot flanges of the roof rack.

In a further embodiment, the fastener can be threaded to move the rocker member legs to an intermediate position and wherein, the fastener may be forced forwards by a user thereby manually shifting the rocker to an open position and lifting the T-bar flanges from the T-slot flanges and then the fastener released again to allow the T-bar flanges and again impinge on the T-slot flanges.

It should be appreciated from the above description that there is provided a leg assembly to connect or link a vehicle roof to a roof rack. Due to the way the leg assembly fits together and locks, it should be appreciated that installation is very easy to achieve and comparatively quicker to achieve than the art which can require use of bolts, hard to reach levers and so on.

In addition, the leg assembly is lightweight yet is strong and ideally has a comparatively aerodynamic external profile thereby reducing wind resistance when the vehicle is driven and therefore also reducing noise and fuel use.

A further advantage is that the leg assembly may be fitted at any point along a channel in an extrusion of a vehicle roof rack whereas art methods that utilise bolts, specific slots and even ratchet and rack systems only allow for one or a limited range of positions in the rack.

A yet further advantage is that an ordinary rack bar may be used without need to modify the bar extrusion. For example, there is no need to punch adjustment slots, bolt apertures, and/or attachment points to the bar extrusion.

A further advantage is that there is no need for the user to look up the recommended spacing published by manufacturers for a specific vehicle model. Instead, the leg assemblies (one on each side of a rack bar) are simply pushed into position by the user until they are satisfied with the orientation and then locked. The leg assembly provided therefore caters to almost any width of vehicle roof and there is no need for the manufacturer to supply fitting dimensions for each make and model as is the case for other art designs.

### BRIEF DESCRIPTION OF THE DRAWINGS

Further aspects of the present invention will become apparent from the following description that is given by way of example only and with reference to the accompanying drawings in which:

FIG. 1 illustrates a perspective view of one embodiment of the leg assembly in an assembled form and linked to a foot and roof rack cross bar;

FIG. 2 illustrates a perspective section view of the leg assembly to expose the leg assembly and other internal aspects of the embodiment;

FIG. 3 illustrates a front elevation section view of the leg assembly with the leg assembly in a fully open position to allow the leg to move in both directions along the rack bar channel;

FIG. 4 illustrates a perspective section detail view of the leg assembly with the leg assembly in a fully open position to allow the leg to move in both directions along the rack bar channel;

FIG. 5 illustrates a front elevation section view of the leg assembly with the leg assembly in a fully closed position to allow the leg to move in both directions along the rack bar channel;

FIG. 6 illustrates a perspective section detail view of the leg assembly with the leg assembly in a fully closed position to allow the leg to move in both directions along the rack bar channel;

FIG. 7 illustrates a front elevation section view of the leg assembly with the leg assembly in an intermediate position to allow the leg to move in both directions along the rack bar channel; and,

FIG. 8 illustrates a perspective section detail view of the leg assembly with the leg assembly in an intermediate position to allow the leg to move in both directions along the rack bar channel.

### BEST MODES FOR CARRYING OUT THE INVENTION

The invention is now described with reference to a detailed description of an embodiment of the leg assembly and a related method of use. The example described refers to a leg assembly whereby the assembly communicates with a T-slot channel inside a roof rack cross bar 4.

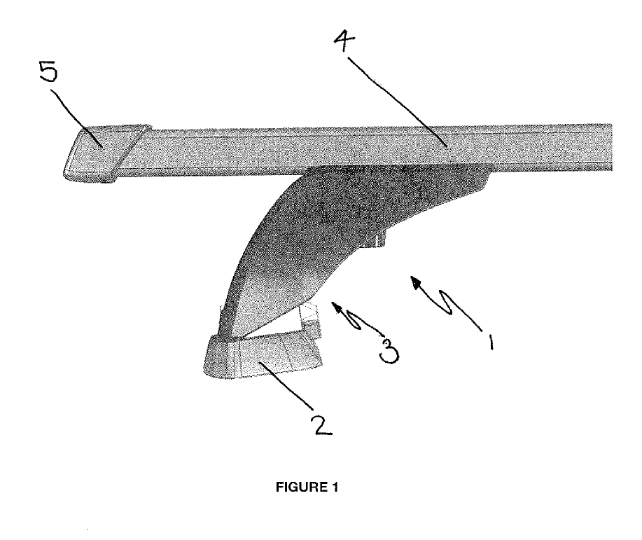

Referring to FIG. 1, a leg assembly generally indicated by arrow 1 is illustrated according to one embodiment of the present invention. The exterior of the leg assembly 1 is shown which includes a leg generally indicated by arrow 3 that is linked to a roof rack cross bar 4 that has an end cap 5. The leg 3 also includes a foot 2. The leg assembly 1 is designed to fit the roof of a vehicle (not shown) on the base of the foot 2 and the leg 3 provides a degree of clearance between the roof and rack 4. The leg 3 includes a cover or enclosure that houses the internal parts of the leg assembly 1.

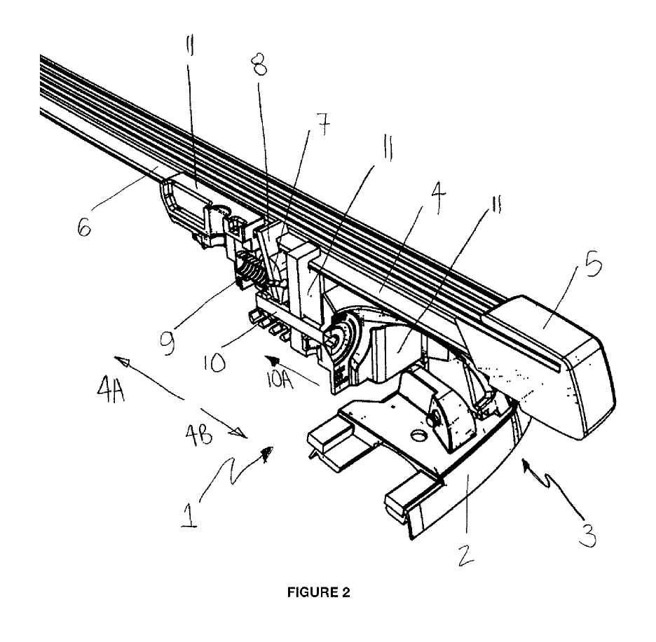

FIG. 2 illustrates a perspective section view of the leg assembly 1. The foot 2 of the leg 3 is still visible along with the roof rack 4 and end cap 5 however, the section view removes half of the enclosure to allow the internal items of the leg assembly 3 to be viewed. The internal items of the leg assembly 1 include a frame section 11 which houses a rocker member 7 linked to a T-bar member 8, a spring 9 and a fastener 10. The T-bar member 8 impinges on the roof rack T-slot flange 6 depending on the orientation of the rocker member 7.

The T-bar member 8 is inclined at an angle 8B with respect to the T-slot flange 6. In the inventor's experience, this angle 8B is critical in order to generate the desired impingement and fixing the leg assembly 1 in place against the roof rack bar 4. Ideal angles 8B are 1 to 25 degrees relative to a vertical plane with one preferred angle 8B being approximately 10 degrees.

The rocker member 7 is important to the operation of the assembly 1 as it forms the pivot point that generates the moment force on the T-bar member 8 flanges 8A. The rocker member 7 includes two legs 7A,7B inter-linked with a nut 12 and fastener 10 as well as the T-bar member 8. The fastener 10 may be pushed forwards in a direction generally shown by arrow 10A and/or threaded and fixed into the assembly 1 to induce a moment on the T-bar member 8 as well. More details on the way the assembly 1 interacts follows below, the main aim of the assembly 1 being to allow the leg assembly 1 to be locked in place on the roof rack 4; to be able to move in either direction indicated by arrows 4A or 4B along the roof rack 4; or to be able to move in only one direction 4A or 4B along the roof rack 4.

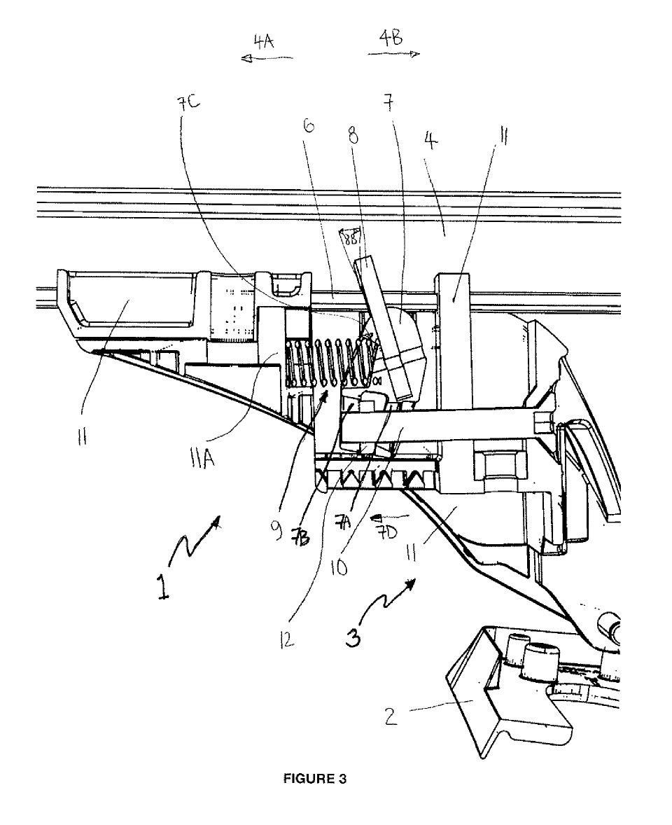

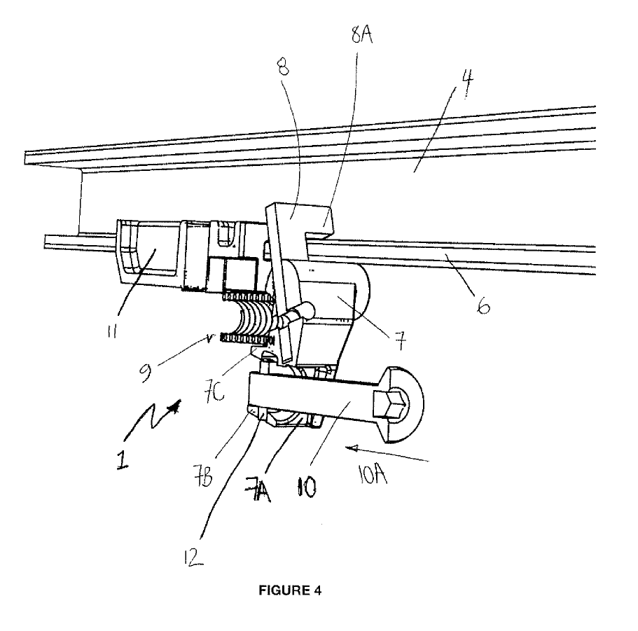

FIG. 3 and FIG. 4 illustrates detail views of the leg assembly 1 when the assembly 1 is in a position that allows for movement in both directions (4A and 4B) along the roof rack 4. In this position, the T-bar member 8 is biased via the rocker member 7 to an open position whereby the T-bar flange 8A is lifted sufficiently far from the roof rack 4 flange 6 that the two flanges 8A,6 do not impinge on one another. This is achieved by forcing the rocker member 7 into a position that lifts the T-bar member 8 that in turn is achieved by moving the rocker member legs 7A, 7B to an extreme position into the leg assembly 1 in direction 7D thereby creating a moment about the rocker member 7 which lifts the T-bar member 8. Movement of the rocker member 7 legs 7A,7B is achieved by unwinding the fastener 10 in direction 7E (if a right hand thread is used) and then pushing the fastener 10 into the frame 11 (direction 7D) fastener receiving aperture thereby moving the rocker member 7 legs into the extreme position noted above and as shown in FIGS. 3 and 4, The fastener 10 communicates with the rocker member 10 via a threaded nut 12. The nut 12 is nested within the rocker member 7 legs 7A,7B and the fastener 10 has a threaded section that mates with the thread of the nut 12. The leg assembly 1 also includes a spring 9 that biases the rocker member 7 against the force imposed by the fastener 10 in the opposing horizontal direction 7D thereby creating a moment around the rocker member 7. The frame 11 includes an aperture 11A to receive the spring 9. The opposing end of the spring is received by an aperture 7C in the rocker member 7.

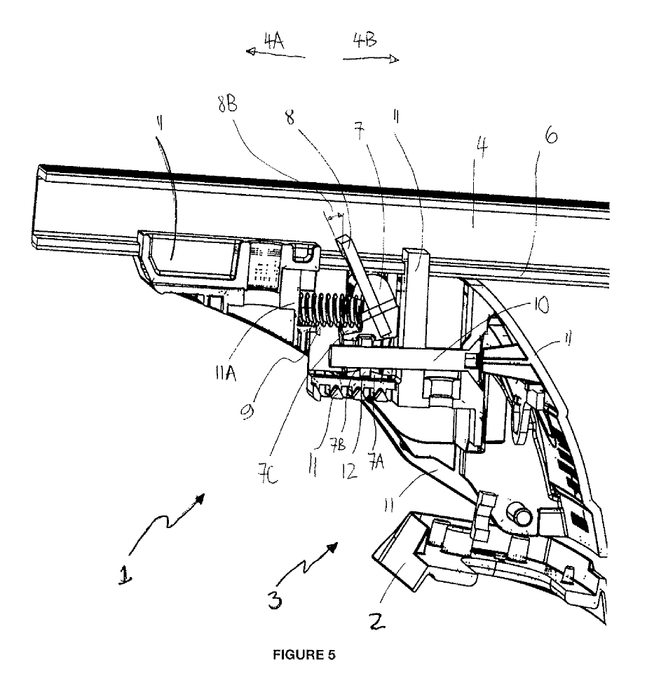

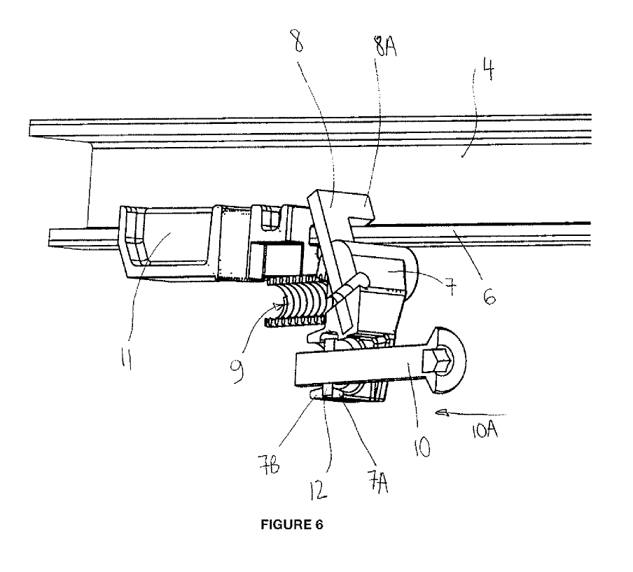

FIG. 5 and FIG. 6 illustrate similar views to FIGS. 3 and 4 but instead, with the leg assembly 1 in a fully locked position whereby the leg assembly 1 is locked in place against the roof rack 4 and does not move in either direction 4A,4B along the roof rack 4 flange 6. In this position, the T-bar member 8 is biased via the rocker member 7 to a closed position whereby the T-bar flange 8A impinges on the roof rack 4 flange 6. This is achieved by forcing the rocker member 7 into a position that forces the T-bar member 8 flange 8A onto the roof rack 4 flange 6 which in turn is achieved by moving the rocker member 7 legs 7A, 7B to an extreme position out of the leg assembly 1 (direction 7E) thereby creating a moment about the rocker member 7 which forces the T-bar member 8 onto the roof rack flange. Movement of the rocker member 7 legs 7A,7B is achieved by winding the fastener 10 into the nut 12 and frame 11 fastener receiving aperture (assumes a right hand thread) thereby moving the rocker member 7 legs 7A,7B into the extreme position noted above and as shown in FIGS. 5 and 6. The inventors have found that once locked, the leg assembly under roof rack loadings remains rigid and locked in place. In addition, the bias action of the leg assembly 1 means that, should the fastener connection fail, there is still sufficient locking force from the spring 9 bias to retain a roof rack load thereby providing an degree of design safety not present in some prior art designs.

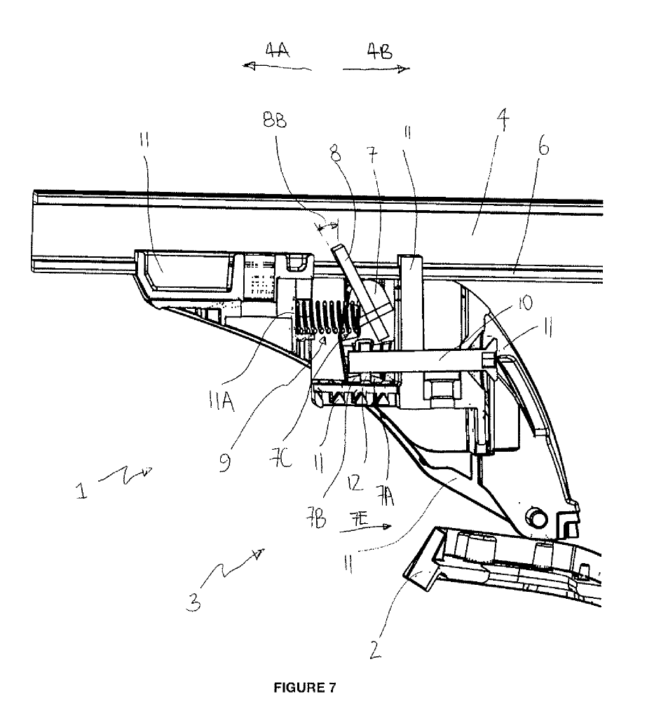

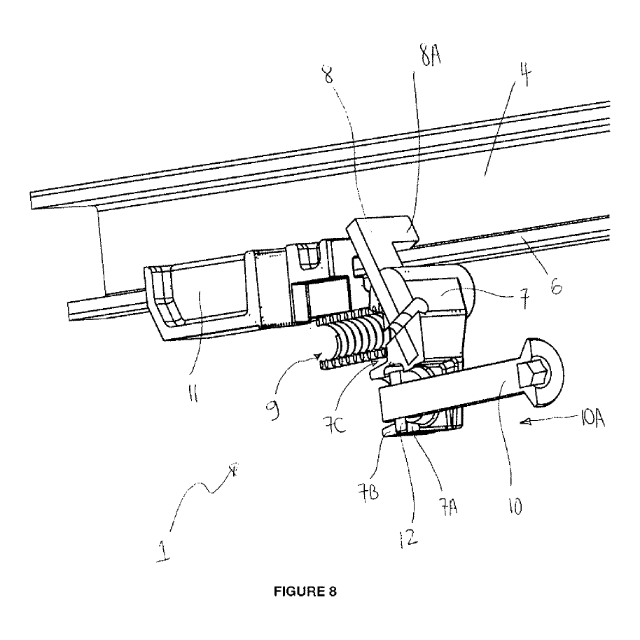

FIGS. 7 and 8 illustrate an intermediate position of the leg assembly 1. In this position the leg assembly 1 may be moved in one direction (typically inwards along the roof rack 4 in direction 4A when being fitted) but not in the opposing direction 4B. Movement inwards is achieved by moving the fastener 10 and nut 12 to a point where the rocker member 7 legs 7A,7B are in a position intermediate to either extreme lateral position 7D,7E as illustrated in earlier Figures. In this intermediate position, the T-bar member 8 flange 8A still impinges on the roof rack 4 flange 6 but, when the user pushes the fastener 10 into the leg assembly 1 frame 11 in direction 7D, the rocker member 7 legs 7A,7B are moved into the frame 11 in direction 7D and forced to an open position against the spring 9 bias which urges the T-bar member 8 to a open or lifted position against the roof rack 4 flange 6. The leg assembly 1 can then be moved forwards along the roof rack 4 in direction 4A. When the fastener 10 is released the spring 9 bias forces the fastener 10 back to a locked position in direction 7E and the leg assembly 1 is locked in position and cannot be drawn backwards 4B. If the leg assembly 1 is pushed backwards in direction 4B once the fastener is released, a moment force is created about the rocker member 7 and the T-bar member 8 flange 8A is forced against the roof rack 4 flange 6 fixing the leg assembly 1 in place.

It may be appreciated that this intermediate position is an ideal position to use when the leg assembly 1 is being fitted to a car. More specifically, in this position, the user places the rack 4 and leg assembly 1 or assemblies (one leg assembly 1 on either end of the roof rack 4) onto the vehicle roof (not shown), so that the leg assemblies 1 are further apart in spread across the roof rack bar 4 than the width of the car roof. The user then pushes the fastener 10 into the leg assembly 1 frame 11 in direction 7D and moves the leg assembly 1 or assemblies 1 forwards in direction 7D into the rack 4 until the desired width is arrived at. The user then releases the fastener 10 that biases back to a locked position in direction 7E and the rack 4 is retained at the desired width. The user can then tighten the fastener 10 to lock the leg assembly 1 in place in both directions. This intermediate position allows the leg assembly 1 to be quickly fitted and holds the rack 4 in a firm position when fitting. This intermediate position also has the advantage that the roof rack 4 and leg assembly 1 provide positive feedback to the user on the rack 4 position and the leg assembly 1 does not loosen off while the user for example, tightens a bolt as in prior art methods. If need be, this intermediate position does allow the user to loosen off the fastener 10 if the user needs to re-set the width and move the leg assembly 1 back out.

The leg assembly 1 described above provides a method of attaching a roof rack 4 to a vehicle roof (not shown). The leg assembly 1 is simple to use and adjust making it easy for installation and fitting. The leg assembly 1 is also strong and provides an extra degree of design security in the event of a failure in one or more of the linkages. The leg assembly 1 also has the advantage of allowing the user to set an infinite number of leg assembly 1 positions with respect to the roof rack 4. As should be appreciated, this allows one or more racks 4 to be fitted to almost any width of vehicle roof. Finally, the leg assembly 1 avoids the need for additional machining of the rack 4 itself as in prior art methods such as avoiding the need to fit a ratchet arrangement inside the rack channel, slots or apertures to receive bolts. Besides reducing manufacturing time, this also means that the leg assembly 1 may be fitted to a standard roof rack extrusion 4 without any need to modify the rack 4 itself.

Aspects of the present invention have been described by way of example only and it should be appreciated that modifications and additions may be made thereto without departing from the scope of the claims herein.

1. A leg assembly that links a roof rack bar to a foot that couples the leg assembly to a vehicle roof wherein the leg assembly includes:
a T-bar member wherein the flanges of the T-bar member are received within a T-slot in a roof rack bar and impinge on the roof rack T-slot flanges;
a rocker member linked to the T-bar member that rotates about an axis in a vertical plane with respect to the roof rack bar;
a biasing device that biases the T-bar member flanges to impinge with the T-slot roof rack bar flanges;
a fastener linked to the rocker member that acts against the bias action of the biasing device and which adjusts the degree of moment about the T-bar member wherein:
the fastener can be adjusted to lock the T-bar flanges against the roof rack flanges and prevent movement of the leg assembly along the roof rack bar and,
the fastener can be adjusted to reduce and/or remove the impingement of the T-bar member flanges on the rack flanges thereby allowing the leg assembly to be moved along the rack bar channel.

2. The leg assembly as claimed in claim 1 wherein the T-bar member flanges impinge on the roof rack bar T-slot flanges at an angle of 1-25 degrees relative to a perpendicular axis with respect to the roof rack.

3. The leg assembly as claimed in claim 2 wherein the impingement angle is in a direction towards the vehicle roof or roof rack inside section.

4. The leg assembly of claim 1 wherein the biasing device is a spring.

5. The leg assembly of claim 1 wherein the leg assembly includes an enclosure moulding that also acts as a frame to retain the leg assembly T-bar member, rocker member, biasing device and at least portion of the fastener.

6. The leg assembly of in claim 5 wherein the rocker member is nested within an aperture in the enclosure that allows for a degree of rotation of the rocker member and provides maximum limits of rotation defined by the aperture size.

7. The leg assembly of in claim 5 wherein only the head of the fastener protrudes from the exterior of the leg assembly enclosure.

8. The leg assembly of claim 1 wherein the T-bar member and rocker member are linked by the T-bar member being received and retained within an aperture in the rocker member.

9. The leg assembly of claim 1 wherein the fastener and rocker member are linked via a nut nested between two rocker member legs and wherein the fastener is received and fixed to the nut via a thread.

10. The leg assembly of claim 9 wherein, when the fastener is threaded into the nut, the rocker legs are pulled towards the fastener head thereby rotating the rocker member and forcing the T-bar member flanges to impinge against the T-slot flanges of the roof rack.

11. The leg assembly of in claim 9 wherein, when the fastener is threaded out of the nut, the rocker legs are pushed away from the fastener head thereby rotating the rocker member and moving the T-bar member flanges away from the T-slot flanges of the roof rack.

12. The leg assembly of claim 9 wherein the fastener can be threaded to move the rocker member legs to an intermediate position and wherein, the fastener may be forced forwards by a user thereby manually shifting the rocker to an open position and lifting the T-bar flanges from the T-slot flanges and then the fastener released again to allow the T-bar flanges and again impinge on the T-slot flanges.

13. The leg assembly of claim 10 wherein, when the fastener is threaded out of the nut, the rocker legs are pushed away from the fastener head thereby rotation the rocker member and moving the T-bar member flanges away from the T-slot flanges of the roof rack.

14. The leg assembly of claim 11 wherein the fastener can be threaded to move the rocker member legs to an intermediate position and wherein, the fastener may be forced forwards by a user thereby manually shifting the rocker to an open position and lifting the T-bar flanges from the T-slot flanges and then the fastener released again to allow the T-bar flanges and again impinge on the T-slot flanges.

15. The leg assembly of claim 6 wherein only the head of the fastener protrudes from the exterior of the leg assembly enclosure.
